(19) United States
(12) Patent Application Publication
(10) Pub. No.: US 2010/0241495 A1
(43) Pub. Date: Sep. 23, 2010

(54) OFFLINE CASHBACK ADVERTISEMENTS

(75) Inventors: Omprakash R. Maniyar, Redmond, WA (US); Ambrish Verma, REDMOND, WA (US); Nitin Chandel, REDMOND, WA (US); Dimitry Berger, REDMOND, WA (US); Abhijit Kundu, WOODINVILLE, WA (US); Sachin Dhawan, REDMOND, WA (US); Ravi Kiran Varma Gottumukkala, REDMOND, WA (US); Subir Singh Sidhu, REDMOND, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 12/408,178

(22) Filed: Mar. 20, 2009

(51) Int. Cl. G06Q 30/00

(52) U.S. Cl. 705/14.1; 705/30

(57) ABSTRACT

Embodiments of the present invention relate to systems, methods and computer storage media for providing an advertisement to a consumer in an online environment for utilization in an offline environment. The offline utilization of the coupon by the consumer allows for an amount owed to an advertisement-service provider by a merchant to be reduced. The advertisement-service provider provides, for a fee, advertising services for the merchant, which includes presenting a coupon to the consumer in an online environment. The consumer is presented with the coupon by the advertisement-service provider on behalf of the merchant. In one embodiment, the consumer stores the coupon for later redemption in an offline environment. The consumer purchases goods or service in an offline environment utilizing the coupon. The advertisement-service provider reduces an amount the merchant owes as a result of the consumer's offline redemption of the coupon.

### BACKGROUND

Typically, advertising platforms have failed to bridge the gap between online research by a consumer and an offline purchase by the consumer. This is in part a result of a typical online environment (e.g., ecommerce Internet site) operating independently from a typical offline environment (e.g., retail store located at 123 Main Street). For example, a consumer's online activity can be monitored by an entity with sufficient rights to facilitate drawing a connection between the online research and an eventual online purchase. However, once the consumer disconnects from the online environment to complete a purchase at an offline store, the correlation between the consumer's online activity (e.g., research and promotion reception) and the consumer's offline purchase is incomplete. It is therefore desirable to bridge the gap between a consumer's online and offline environments.

The above-described deficiencies of today's advertising platforms are merely intended to provide an overview of some of the problems of conventional systems and are not intended to be exhaustive. Other deficiencies and corresponding benefits of some of the various nonlimiting embodiments may become further apparent upon review of the following detailed description.

### SUMMARY

Embodiments of the present invention relate to systems, methods, and computer storage media for providing a coupon to a consumer in an online environment. A coupon is provided to the consumer in an online environment. The coupon may then be stored in a coupon storage account that is associated with the consumer. During a purchase of goods or services from a merchant in an offline environment, the coupon is utilized to provide a benefit to the consumer. As a result of the redemption of the coupon, the coupon may be identified as being utilized for the offline purchase. A financial amount the merchant owes to an advertisement-service provider may then be reduced as a result of the utilization of the coupon.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 depicts an exemplary computing device suitable for implementing embodiments of the present invention;

FIG. 2 depicts an environment for reducing merchant-related expenses owed to an advertisement-service provider in response to an offline consumer purchase, the environment is suitable for implementing embodiments of the present invention;

FIG. 3 depicts a block diagram illustrating a method for reducing merchant-related expenses owed to an advertisement-service provider in response to an offline consumer purchase in accordance with an embodiment of the present invention;

FIG. 4 depicts a block diagram illustrating a method of a consumer locating and storing a coupon online for utilization offline in accordance with an embodiment of the present invention;

FIG. 5 depicts a block diagram illustrating a method of utilizing a coupon for an offline purchase that results in a reduction of debt owed by a merchant to an advertisement-service provider in accordance with an embodiment of the present invention;

FIG. 6 depicts a block diagram illustrating a method for reducing merchant-related expenses owed to an advertisement-service provider in response to an offline consumer purchase in accordance with an embodiment of the present invention;

FIG. 7 depicts a block diagram illustrating another method for reducing merchant-related expenses owed to an advertisement-service provider in response to an offline consumer purchase in accordance with an embodiment of the present invention; and

FIG. 8 depicts a block diagram illustrating yet another method for reducing merchant-related expenses owed to an advertisement-service provider in response to an offline consumer purchase in accordance with an embodiment of the present invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies.

Embodiments of the present invention relate to systems, methods, and computer storage media for providing a coupon to a consumer in an online environment. The coupon is stored in association with the consumer in a coupon storage account. The consumer initiates the purchase of goods or service from a merchant in an offline environment. The coupon is utilized to provide a benefit to the consumer during the offline purchase. An indication is provided that indicates the coupon was utilized in the offline transaction. A financial amount the merchant owes to an advertisement-service provider is reduced as a result of the utilization of the coupon.

Accordingly, in one aspect, the present invention provides a method for reducing merchant-related expenses owed to an advertisement-service provider in response to an offline consumer purchase. The method includes generating a coupon in response to an online query submitted by a consumer. The coupon is associated with a merchant. The method also includes providing the coupon to the consumer. The coupon provides an economic benefit to the consumer when the coupon is utilized offline. The method also includes receiving, from the merchant, an indication of an offline utilization of the coupon by the consumer. The method additionally includes reducing a financial amount owed to the advertisement-service provider by the merchant in response to the offline utilization of the coupon by the consumer.

In another aspect, the present invention provides computer storage media having computer-executable instructions embodied thereon for performing a method for reducing merchant-related expenses owed to an advertisement-service provider in response to an offline consumer purchase. The method includes receiving a request from a consumer to digitally store a coupon. The coupon entitles the consumer to an economic benefit when the coupon is utilized. The method includes storing the coupon in association with the consumer. The method also includes receiving a request for the coupon. The method additionally includes providing information of the coupon. The information includes a unique identifier of the coupon useable by a merchant to apply the economic benefit of the coupon to an offline purchase by the consumer. The method also includes reducing a financial amount the merchant owes to the advertisement-service provider as a result of the offline purchase by the consumer.

A third aspect of the present invention provides a system for computer-readable media having computer-executable instructions embodied thereon for performing a method for reducing merchant-related expenses owed to an advertisement-service provider in response to an offline consumer purchase. The method includes receiving a request from a merchant to provide a coupon in response to an online search query for an identified keyword. The method also includes receiving an online search query from a consumer. The online search query is comprised of the identified keyword. The method additionally includes communicating the coupon to the consumer. The method also includes receiving a request from the consumer to store the coupon. The coupon is stored in association with an identifier of the consumer. The method also includes receiving a request for the coupon from the merchant. The request includes the identifier of the consumer. The method further includes receiving an indication from the merchant of the utilization of the coupon by the consumer to make an offline purchase from the merchant. The method also includes crediting a merchant account, wherein the credit reduces a financial amount owed to the advertisement-service provider by the merchant.

Having briefly described an overview of embodiments of the present invention, an exemplary operating environment suitable for implementing embodiments hereof is described below.

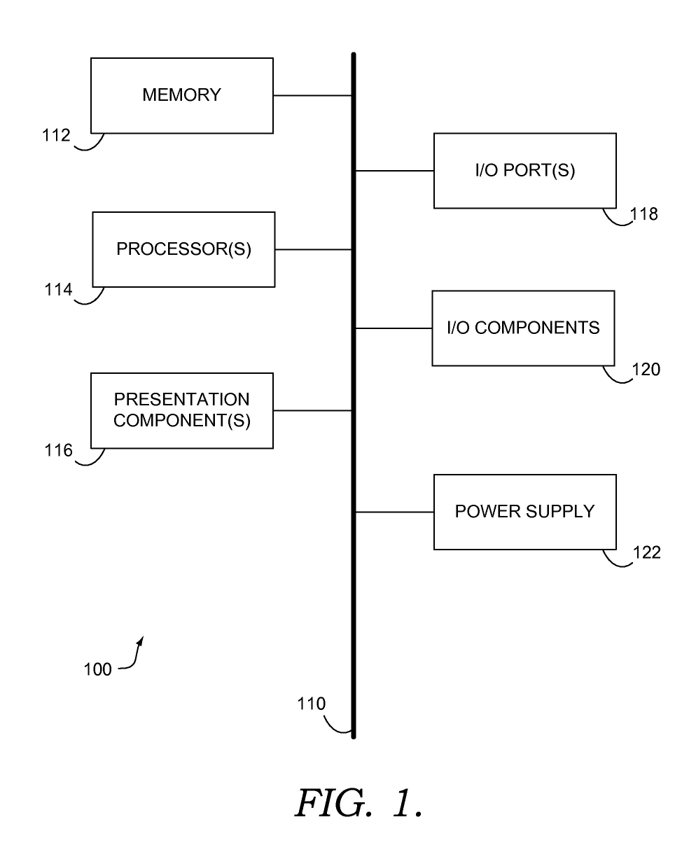

Referring to the drawings in general, and initially to FIG. 1 in particular, an exemplary operating environment suitable for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of modules/components illustrated.

Embodiments may be described in the general context of computer code or machine-useable instructions, including computer-executable instructions such as program modules, being executed by a computer or other machine, such as a personal data assistant or other handheld device. Generally, program modules including routines, programs, objects, modules, data structures, and the like, refer to code that performs particular tasks or implements particular abstract data types. Embodiments may be practiced in a variety of system configurations, including handheld devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation modules 116, input/output (I/O) ports 118, I/O modules 120, and an illustrative power supply 122. Bus 110 represents what may be one or more busses (such as an address bus, data bus, or combination thereof). Although the various blocks of FIG. 1 are shown with lines for the sake of clarity, in reality, delineating various modules is not so clear, and metaphorically, the lines would more accurately be grey and fuzzy. For example, one may consider a presentation module such as a display device to be an I/O module. Also, processors have memory. The inventors hereof recognize that such is the nature of the art, and reiterate that the diagram of FIG. 1 is merely illustrative of an exemplary computing device that can be used in connection with one or more embodiments. Distinction is not made between such categories as “workstation,” “server,” “laptop,” “handheld device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier waves or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O modules 120. Presentation module(s) 116 present data indications to a user or other device. Exemplary presentation modules include a display device, speaker, printing module, vibrating module, and the like. I/O ports 118 allow computing device 100 to be logically coupled to other devices including I/O modules 120, some of which may be built in. Illustrative modules include a microphone, joystick, game pad, satellite dish, scanner, printer, wireless device, and the like.

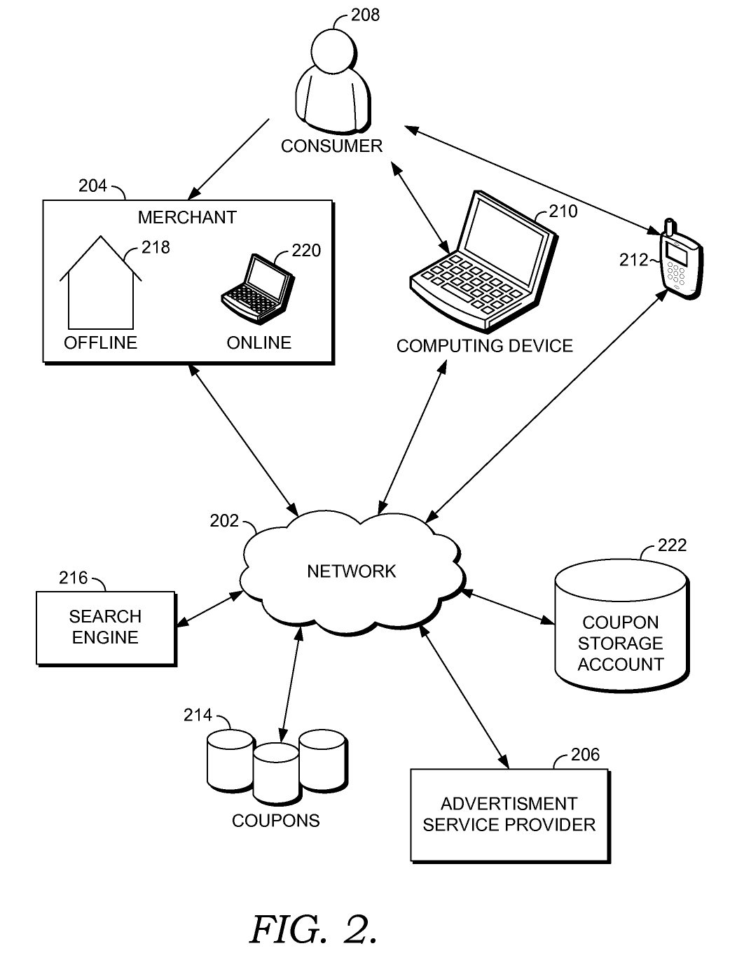

With reference to FIG. 2, a block diagram is provided illustrating an exemplary environment 200 in which embodiments of the present invention may be employed. It should be understood that this and other arrangements described herein are set forth only as examples. Other arrangements and elements can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components, entities, and devices not shown, the environment 200 may include a network 202, a merchant 204, an advertisement-service provider 206, a consumer 208, a computing device 210, a mobile device 212, a coupon store 214, a search engine 216, and a coupon storage account 222. Any of the components and devices shown in FIG. 2 may be any type of computing device, such as computing device 100 described with reference to FIG. 1, for example. The components, entities, and devices may communicate with each other via the network 202, which may include, without limitation, one or more local area networks (LANs) and/or wide area networks (WANs). Such networking environments are commonplace in offices, enterprise-wide computer networks, intranets, and the Internet.

The merchant 204 is a provider of goods and/or services. The merchant 204 includes an online merchant environment 220 and an offline merchant environment 218. The offline merchant environment 218 is a tangible environment that allows for the physical presence of one or more consumers to interact with the merchant 204. For example, an offline merchant environment 218 may be referred to as a “brick and mortar” storefront. This term symbolizes that the offline merchant environment 218 is comprised of physical and tangible elements. An offline merchant environment is contrary to the online merchant environment 220, which is a virtual environment that is neither tangible nor physical in a traditional sense. An example of the online merchant environment 220 includes an Internet site that offers for sale the goods and/or services of the merchant 204.

For example, a hypothetical merchant, “Ted's Shoes,” has a physical retail store located at 123 Main Street, Kansas City, Mo. Ted's Shoes also has an online retail presence at WWW.TEDSSHOESTORE.COM. A consumer is able to visit the retail store at 123 Main Street, select a pair of shoes, try on the shoes, and purchase the shoes. The same consumer could also utilize an Internet browser to visit the WWW.TEDSSHOESTORE.COM, where the consumer can browse a plurality of images and other media to select a pair of shoes, add the shoes to a virtual shopping basket, and complete the purchase of the shoes utilizing an online payment system. In both scenarios, the consumer is able to select a pair of shoes and purchase the shoes. However, the offline merchant environment, i.e., 123 Main Street, and the online merchant environment, i.e., WWW.TEDSSHOESTORE.COM, are very different and each has unique circumstances that are not shared between the two environments.

The purchase of a product or service by a consumer in an online merchant environment allows for the actions of the consumer to be tracked in a relational manner. For example, a log (e.g., history of online locations visited) may be maintained for a consumer that represents the one or more Internet sites the consumer has visited. In addition to maintaining a list of the sites browsed by the consumer, descriptions of content, times associated with the browsing activity, and other information that would be useful for reconstructing the consumer's online activity is maintained by the log. The log may therefore be utilized to identify a correlation between two activities of the consumer in an online environment. For example, when a consumer searches for a product utilizing a search engine, the log may capture this activity. Further, an online advertisement or other online offer may be presented to the consumer as a result of the search. The presentation of the advertisement or other offer may also be captured by the log. When the consumer then performs an online action that is in response to the presentation of the advertisement or other offer, the log may then be referenced to identify a correlation between the online action performed by the consumer (e.g., purchase of a product) and the presentation of the advertisement or other offer. As a result, a reliable method of monitoring the consumer's actions is possible.

In addition to a log, additional mechanisms are able to facilitate the monitoring and tracking of a consumer's online activity. For example, a consumer's computing device may be identified or marked with a token or a cookie to provide persistent information related to the consumer. Therefore, in this example, when a consumer views an online advertisement, the consumer's computing device is populated with a cookie or other persistence identifier. Therefore, when the user consummates an online purchase of a product or service identified in the advertisement, a correlation between the advertisement and the resulting purchase is therefore identifiable.

In yet another exemplary embodiment, a consumer views an online advertisement that includes a link that allows a user to become registered as having viewed the online advertisement. Upon registration, the consumer is directed to an online merchant environment associated with the advertisement. The uniform resource locator used in conjunction with the consumer's visit to the online merchant environment is altered to uniquely identify the consumer as having viewed the online advertisement.

The online merchant environment therefore facilitates monitoring and tracking a consumer's activity. For example, a third party, such as the advertisement-service provider 206, is able to follow the activities of the consumer from a point of viewing an online advertisement to the consummation of a purchase in an online merchant environment as a result of the third party having the ability to utilize persistent information. Additionally, the tracking of the consumer's activities is reliable because the flow of activity is contained to a single environment, the online merchant environment.

The ability of a third party to track the activity of a consumer is hampered when the activity spans both an online and an offline environment. For example, traditional techniques for monitoring activity of a consumer rely on persistent information (e.g., cookies, tokens, URL rewrites). However, persistent information is limited to the confines of an online environment and cannot bridge the online environment to the offline environment. Therefore, the ability to identify a correlation between a consumer that is presented with an online advertisement (e.g., coupon) and a consumer that purchases a product or service offline is not possible with traditional techniques utilized to accomplish the same in an all online environment.

As a result, a distinction between the offline merchant environment 218 and the online merchant environment 220 is critical. The distinction between an offline and an online merchant environment is material because of the barriers that must be overcome to implement a method for reducing merchant-related expenses owed to an advertisement-service provider in response to a consumer purchase. The barriers and the distinctions will become apparent throughout the present disclosure.

An advertisement is a promotion of a product, service, or entity. An advertisement may include a financial incentive for a consumer to purchase a product or service. An advertisement may include information relevant to a particular product, service, or entity, such as the merchant 204. Advertisements may be comprised of textual elements, static media (e.g., still pictures, figures, images, objects), dynamic media (e.g., video, audio, SWF media based content), information (e.g., hours of operation, online address, offline address, restrictions, limitations), a unique identifier (e.g., barcode) or the like. For example, an advertisement may include a merchant's name and logo, textual elements describing a promotion, a map, an online merchant environment location information (e.g., URL), and an offline merchant environment location information (e.g., street address). Additionally, a dynamic advertisement may include one or more hyperlinks that provide additional options. For example, a consumer may receive directions to a location from a known location, identified location, or detected location. The consumer may also print the advertisement, email the advertisement, and/or communicate the advertisement (e.g., communicate elements of the advertisement by way of Short Message Service to a mobile device). Further, in an exemplary embodiment, a consumer may store the advertisement for later utilization or the like. A coupon is an exemplary advertisement.

The consumer 208 is an entity that consummates the purchase of a product or service. In an exemplary embodiment, the consumer 208 is a human being. In an additional embodiment, the consumer 208 represents an organization, a company, a group, and/or a government. For example, a company may employee one or more automated computing devices that review online advertisements in an attempt to identify economic opportunities. The company then utilizes an agent for consummating the offline purchase.

In an exemplary embodiment, the consumer 208 is capable of browsing an online environment, such as the Internet, by way of the computing device 210. The consumer 208 uses the computing device 210 to access the search engine 216 in an attempt to search for a particular product or service. In addition to utilizing the computing device 210, the consumer may utilize the mobile device 212 to access an online environment to search for a product or service.

The advertisement-service provider 206 is a provider of advertisement services for the merchant 204. For example, the advertisement-service provider 206 is an entity that populates search engine results with one or more advertisements. The advertisements that populate the search engine results are selected, in an exemplary embodiment, based on one or more keywords and/or phrases of a search query from which the search results are based. The advertisements, in this example, that are presented along with search results are associated with the one or more keywords and phrases by a merchant for which the advertisement is directed. For example, the merchant 204 may pay (e.g., provide economic compensation) the advertisement-service provider 206 in return for the advertisement-service provider 206 presenting an advertisement in search results provided to the consumer 208. Examples of the advertisement-service provider 206 include, but are not limited to, MICROSOFT AD CENTER, GOOGLE AD SENSE, and YAHOO! SEARCH MARKETING.

Typically, the advertisement-service provider 206 agrees to present one or more advertisements on-behalf of the merchant 204 in an online environment in exchange for financial compensation (e.g., the advertisement is presented in combination with search results, the advertisement is presented on a web page with contextually related content or concepts). The merchant 204 identifies one or more keywords of a search query that should trigger the presentation of an advertisement. Therefore, when the consumer 208 enters a search query by way of the computing device 210 into the search engine 216 by way of the network 202, the advertisement-service provider 206 supplies one or more advertisements to present to the consumer along with search results. The advertisement-service provider 206 is associated with the search engine 216 in an exemplary embodiment, therefore, the search engine 216 is a service affiliated with the advertisement-service provider 206. This affiliation allows advertisement-service provider 206 to control what is returned in the search results, such as which advertisements are included with the search results.

The coupon store 214 is a data store that is maintained by the advertisement-service provider 206 to store one or more advertisements. The coupon store 214 is accessed by the advertisement-service provider 206 to populate search results or other online environments (e.g., web pages, email, maps) with an advertisement. For example, the merchant 204 may have a plurality of advertisements that are available to be presented to the consumer 208. The plurality of advertisements are stored in the coupon store 214 for later presentation.

The coupon storage account 222 is a data store utilized by the consumer 208 to store one or more advertisements for later utilization. For example, the consumer 208 is researching a product online by way of the computing device 210; as a result, the consumer 208 is presented with an advertisement. The consumer 208 elects to save the advertisement to facilitate later access and eventual utilization of the advertisement.

The consumer 208, in an exemplary embodiment, establishes an account with the advertisement-service provider 206, wherein the account allows for the consumer 208 to store one or more advertisements originally supplied by the advertisement-service provider 206. Therefore, when the consumer 208 utilizes the advertisement at a later time in an offline environment, the advertisement-service provider 206 is capable of monitoring the consumer 208 account. In this example, the account established with the advertisement-service provider 206 by the consumer 208 utilizes the coupon storage account 222 to maintain selected advertisements on behalf of the consumer 208.

The mobile device 212 is a device functional to communicate over a wireless network. A wireless network is a network that utilizes wireless technology. Wireless technology may include any wireless technology including, but not limited to, Third Generation Partnership Project (3GPP), the Third Generation Partnership Project 2 (3GPP2), IEEE 802.16 (e.g., WirelessMAN), IEEE 802.11 (e.g., WiFi), WIMAX, and the like.

The mobile device 212 may allow the consumer 208 to locate one or more advertisements, such as coupons, in an online environment, similar to the computing device 210. Additionally, the mobile device 212 may be utilized by the consumer 208 in the offline merchant environment 218 to provide evidence of a particular advertisement. For example, the consumer 208 may access the coupon storage account 222 by way of the mobile device 212. Upon accessing the coupon storage account 222, the mobile device may be utilized to select a particular coupon from the coupon storage account 222. The selected coupon is then presented by way of the mobile device 212 to allow the consumer 208 to gain the benefit of the selected coupon. In an exemplary embodiment, the selected coupon includes a unique identifier, such as a bar code. The selected coupon along with a bar code is displayed on the mobile device so that a bar code reader of the merchant 204 may identify the barcode and apply the benefit of the coupon to a purchase by the consumer 208. In yet an additional embodiment, the consumer 208 views an online advertisement that includes an option for information of the coupon to be communicated to the user by way of the mobile device 212. The consumer 208 elects to have the coupon communicated to the mobile device, where the coupon is communicated as a Short Message Service (i.e., text message) to the mobile device 212.

In an exemplary, nonlimiting, embodiment of the present invention, the consumer 208 engages in a session of online research for a particular pair of shoes, “easy sneakers.” The consumer 208 utilizes the computing device 210 to access the search engine 216 by way of the network 202. The consumer enters a search query for the search engine 216 for the easy sneakers. Prior to the consumer 208 entering the search query, the merchant 204, in this example Ted's Shoes, registered with the advertisement-service provider 206 for the advertisement-service provider 206 to provide an advertisement in response to a search query. As part of the registration, the Ted's Shoes agreed to compensate the advertisement-service provider 206 for the presentation of the advertisement in response to one or more keywords. Ted's Shoes, in this example, indicated that a search query including the terms “easy” and “sneakers” would trigger the presentation of the advertisement. In return for each presentation of the advertisement with a search query including the terms “easy” and “sneaker” Ted's Shoes will compensate advertisement-service provider 206, $1.00.

Therefore, when the consumer 208 enters the online search query of “easy sneakers” into the search engine, the advertisement-service provider 206 accesses Ted's Shoes advertisement stored in the coupons store 214. The advertisement is included with search results from the search engine 216. The Consumer 208 is provided with the search results as well as the Ted's Shoe advertisement. Upon reviewing the advertisement online, the consumer 208 indicates, by selecting on the advertisement, the advertisement is to be stored in the coupon storage account 222. The advertisement is therefore accessible by way of the coupon storage account 222 for a later online purchase or an offline purchase of the easy sneakers. In this example, the consumer 208 also views a map associated with the advertisement, where the advertisement-service provider 206 in conjunction with the search engine 216 identify the closest location of Ted's Shoes to the identified location of the consumer 208. Therefore, while Ted's Shoes may have multiple locations, the map indicates the geographically closest location to the location of the consumer 208. The consumer leaves the online environment to purchase the easy sneakers at a brick and mortar location of Ted's Shoes.

Continuing with this example, the consumer 208 walks into Ted's Shoes store (i.e., the offline merchant environment 218) and locates a pair of easy sneakers to be purchased. Once the consumer is at the physical checkout of the Ted's Shoes, the consumer 208 desires to utilize the coupon for Ted's Shoes that was previously stored. The consumer 208 may then access a printed copy of the advertisement that the Ted's Shoes employee may enter. Additionally, the consumer 208 may access the coupon storage account 222 to locate a unique identifier of the advertisement. For example, a bar code may be displayed on the mobile device 212 so that the Ted's Shoe employee may scan the barcode from the mobile device 212 screen. The mobile device 212 may also provide another unique identifier of the advertisement that is entered by the Ted's Shoes employee. Further, the Ted's Shoes employee may also access the coupon storage account 222 on behalf of the consumer 208 to identify if an applicable advertisement is accessible.

Continuing with this example, upon entering the advertisement at the point of sale, the consumer 208 receives a benefit from the utilization of the coupon. For example, a percentage of the cost of the hypothetical easy sneakers is reduced from the final purchase price. The benefit received from the utilization of the advertisement is one motivating factor for the consumer 208 to use the advertisement.

In addition, the above example may continue such that Ted's Shoes reduces an amount owed to the advertisement-service provider 206 as a result of the utilization of the coupon by the consumer 208. As previously discussed with this example, each time the advertisement for Ted's Shoes is presented, Ted's Shoes is obligated to compensate the advertisement-service provider 206, $1.00. As a result, over time, Ted's Shoes may owe (e.g., incur a debt) advertisement-service provider 206 a sizeable economic amount. Therefore, Ted's Shoes may enter into an agreement with the advertisement-service provider 206 that a certain percentage of the total amount owed to the advertisement-service provider 206 may be reduced as a result of the utilization of the advertisement by one or more consumers. The debt owed to the advertisement-service provider 206 is reduced for the offline or online utilization of the advertisement. This example therefore provides a benefit to the consumer 208 in that the purchase price was reduced as a result of the utilization of the advertisement. Ted's Shoes benefits by reducing the amount of debt owed to the advertisement-service provider 206. The advertisement-service provider 206 benefits in that the consumer 208 used the search engine 216 associated with the advertisement-service provider 206 and Ted's Shoes elected to use the services of the advertisement-service provider 206. Therefore, the consumer 208, Ted's Shoes, and the advertisement-service provider 206 all derived a benefit from this example.

While the previous example included the utilization of an Internet search engine and the corresponding search results, it is contemplated that an advertisement is presented on additional web pages. For example, a product or service review site may include an advertisement, a blog or other commentary source may include an advertisement, and other web pages that may include contextually related matter or concepts to a particular advertisement or advertising entity

Accordingly, any number of components, entities, and devices may be employed to achieve the desired functionality within the scope of embodiments of the present invention. Although the various components of FIG. 2 are shown with lines for the sake of clarity, in reality, delineating various components is not so clear, and metaphorically, the lines would more accurately be grey or fuzzy. Further, although some components of FIG. 2 are depicted as single blocks, the depictions are exemplary in nature and in number and are not to be construed as limiting.

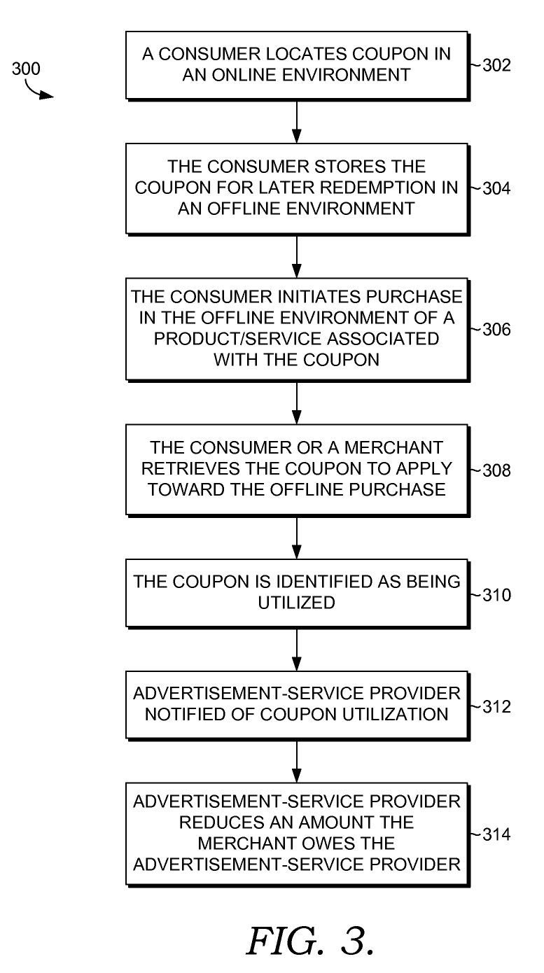

Turning to FIG. 3 that depicts a block diagram illustrating a method 300 for reducing merchant-related expenses owed to an advertisement-service provider in response to an offline consumer purchase in accordance with an embodiment of the present invention. At a step 302, a consumer locates a coupon in an online environment. For example, the consumer may be searching the Internet utilizing a search engine. The search engine returns a number of results that include paid advertisements. One of the paid advertisements is a coupon the consumer identifies as being applicable to the online research being conducted. In an additional example, the consumer is researching at a plurality of web pages that discuss the product or service the consumer is researching. The web page includes one or more advertisements. The consumer identifies one of the advertisements as being of interest.

At a step 304, the consumer stores the coupon for later redemption in an offline environment. The consumer is not limited to redeeming the coupon in an offline environment. Storage of the coupon may include storing a version of the coupon or information associated with the coupon. For example, a unique identifier of the coupon may be stored by the consumer, where the unique identifier is, at least in one option, the information necessary for the consumer to utilize the coupon. Additionally, the coupon may only be stored for the period the coupon is valid. This feature allows for the coupons that are stored by the consumer to be limited to coupons that are currently available.

At a step 306, the consumer initiates a purchase, in the offline environment, of a product or service associated with the coupon. The initiation of the purchase may include approaching an employee of a merchant associated with the coupon to pay for the product or service. In one embodiment, the initiation of the purchase does not include the completion of the purchase as the benefit of the coupon is applied prior to completing the purchase. In an additional embodiment, the initiation of the purchase includes the completion of the purchase at the offline environment and the benefit of the coupon is achieved through a later rebate type program where the consumer provides the proof of purchase and information associated with the coupon to an entity to receive the benefit.

At a step 308, the consumer or a merchant associated with the coupon retrieves the coupon to apply the coupon toward the offline purchase. For example, the consumer may provide a printed copy, an electronic copy, or a unique identifier of the coupon to the merchant to receive the benefit of the coupon. Additionally, the merchant may access an online environment to retrieve the coupon on behalf of the consumer. For example, the point of sale for the merchant may have Internet access, which facilitates retrieving one or more applicable coupons from the consumer coupon storage account. Once applied to the purchase, the coupon is utilized.

At a step 310, the coupon is identified as being utilized. Identification of being utilized may include indicating the coupon is used in the consumer coupon storage account. The identification may also include indicating in a database maintained by the merchant or an advertisement-service provider that the coupon was utilized. Further identifying the coupon is utilized may include physically marking the coupon if presented in physical form (e.g., printed form).

At a step 312, an advertisement-service provider is notified of the utilization of the coupon. For example, the advertisement-service provider may desire to maintain an accounting of the coupons that are utilized to properly credit the merchant's account. In this example, the advertisement-service provider is sponsoring, at least part of, the economic benefit the consumer received from the utilization of the coupon. Because the consumer is consummating the purchase in an offline environment, and the positioning of an advertisement-service-provider representative at all offline environments is impractical, the merchant is responsible for covering the advertisement-service provider's portion of the economic benefit provided to the consumer. Therefore, the merchant desires to be reimbursed for the portion of the economic benefit bestowed upon the consumer as a result of the utilization of the coupon. In order to facilitate an accurate reimbursement to the merchant from the advertisement-service provider, the advertisement-service provider is notified of the coupon utilization.

At a step 314, the advertisement-service provider reduces an amount the merchant owes the advertisement-service provider. For example, the advertisement-service provider provides one or more advertisements to consumers on behalf of the merchant. In return for providing the one or more advertisements to the consumers, the merchant agrees to compensate the advertisement-service provider. Therefore, with each presentation of an advertisement, the debt owed to the advertisement-service provider by the merchant may increase. In an exemplary embodiment, the merchant and the advertisement-service provider agree to reduce the amount the merchant owes to the advertisement-service provider for a utilization of an advertisement by a consumer. As previously discussed, the advertisement-service provider may be motivated to enter into such an agreement to attract additional merchants and consumers.

In an exemplary embodiment, the amount the advertisement-service provider reduces the merchant's debt is a percentage of the benefit provided to a consumer as a result of the utilization. In an additional embodiment, the amount reduced is based, at least in part, on a predetermined amount. Further, in an additional embodiment, the amount reduced is limited to a predetermined percentage of the total amount owed to the advertisement-service provider by the merchant over a specified period. In an additional embodiment, the amount reduced is based, at least in part, on how the coupon was presented to the merchant (e.g., printed copy, digital copy, or merchant look-up of consumer's coupon account). Therefore, the amount owed to the advertisement-service provider by the merchant is reduced as a result of the utilization of the coupon.

In an exemplary embodiment, a concept of utilizing a “piggybank” has been contemplated. A merchant is provided a piggybank by an advertisement-service provider. The advertisement-service provider funds the piggybank on behalf of the merchant. The funding amount may be variable or predetermined percentage of the amount spent by the merchant with the advertisement-service provider. For example, if a merchant spends $1000 on advertising with an advertisement-service provider and 75% is a predetermined funding percentage to be utilized for the merchant's piggybank, then $750 is deposited into the merchant's piggybank. As a result, the piggybank may be used to fund the benefits received from one or more coupons redeemed by a consumer for a merchant's products or service. Additionally, a redemption benefit associated with a coupon may be dynamic and changing based on the merchant's piggybank. For example, as a balance of a piggybank declines, so may the benefit associated with a coupon. This change in a coupon's benefit allows for the merchant and advertisement-service provider to adjust to the demand associated with one or more coupons.

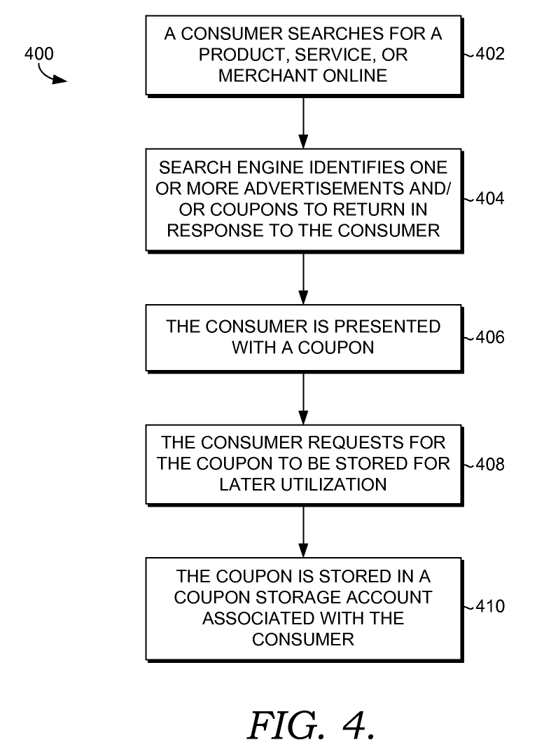

Turning to FIG. 4 that depicts a block diagram illustrating a method 400 of a consumer locating and storing a coupon online for utilization offline in accordance with an embodiment of the present invention. At a step 402, a consumer searches for a product, service, or a merchant online. As previously discussed, the searching may involve an Internet search engine. For example, the consumer may enter one or more keywords as a search query in the search engine. At a step 404, the search engine identifies one or more advertisements and/or coupons to return in response to the consumer. For example, the keywords entered in connection with the search query may be identified by a merchant as trigger words that the merchant desires to cause the presentation of an advertisement, such as a coupon. In addition, in this example, the search engine may also identify one or more web pages that include information contextually relevant to the search query. Therefore, the search engine returns results to the consumer that includes both contextually relevant web pages and advertisements.

At a step 406, the consumer is presented with a coupon. The presentation of the coupon may include the displaying of the coupon on a mobile device, on a display of a computing device, or as a printed embodiment. In an exemplary embodiment, the presentation of the coupon includes presenting, on a display device coupled to a computing device, a search result page populated by the search engine, where the search result pages include a combination of web pages accessible by way of the Internet and the coupon.

At a step 408, the consumer requests for the coupon to be stored for later utilization. For example, the consumer may select the coupon from the search engine results. The selection, in an embodiment, includes the manipulating of a human interface device (e.g., mouse, scroll wheel, keyboard, touch screen) to indicate to a computing device a desire to select the coupon. The coupon may include a link that automatically allows the storage of the coupon on a coupon storage account associated with the consumer. Additionally, the coupon may include a selectable option that allows the consumer to select an option to be performed in association with the coupon (e.g., print, store, display directions, and call a phone number).

At a step 410, the coupon is stored in a coupon storage account associated with the consumer. The storage of the coupon allows for the consumer to utilize the coupon in an offline environment. For example, the consumer may access the coupon storage account utilizing a mobile device or a merchant may request the coupon from the coupon storage account associated with the consumer. The storage of the coupon facilitates bridging the gap between the online research (e.g., step 402) and the offline purchase of goods or services associated with the coupon.

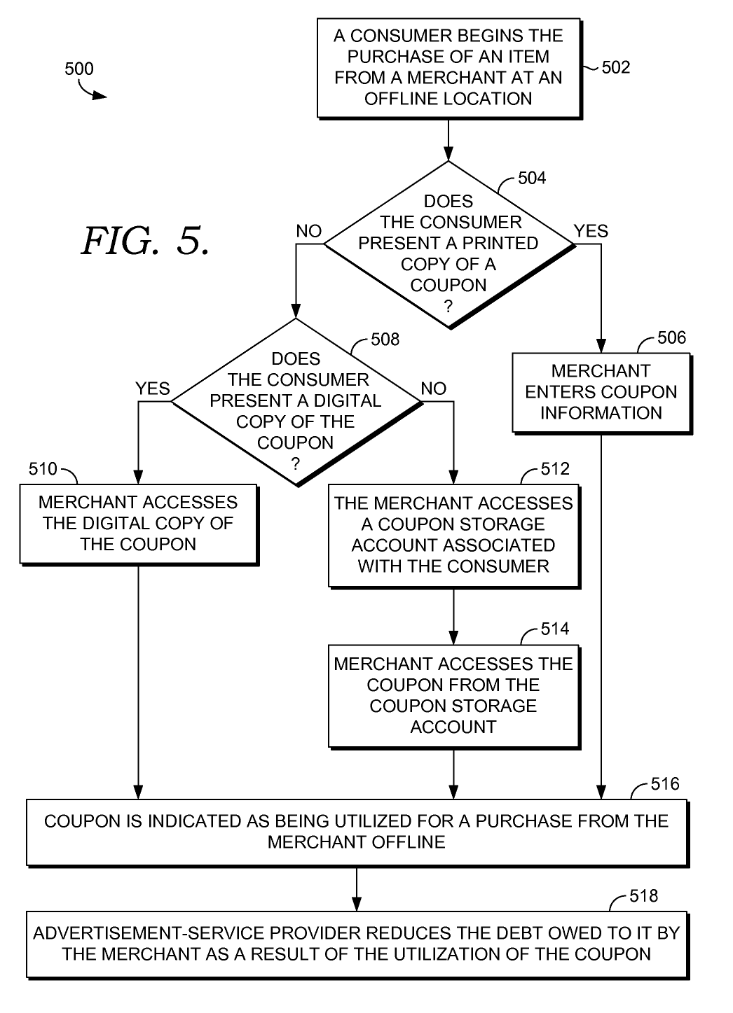

Turning to FIG. 5 that depicts a block diagram illustrating a method 500 of utilizing a coupon for an offline purchase that results in a reduction of debt owed by a merchant to an advertisement-service provider in accordance with an embodiment of the present invention. At a step 502, a consumer begins the purchase of an item from a merchant at an offline location. While the method 500 is directed to the purchase of an item, it is understood that the method 500 is not limited to the purchase of an item, but instead may also include the purchase, lease, or similar transactions for both an item and a service. For example, the consumer may enter into a retail location of Ted's Shoes located at 123 Main Street with the intent of purchasing a pair of “easy sneakers.” Beginning the purchase of the easy sneakers includes approaching a point of sale with the intention of consummating a transaction which transfers rights in the easy sneakers to the consumer.

At a decision 504, does the consumer present a printed copy of a coupon? For example, the consumer initiates the purchasing of the easy sneakers at a point of sale; does the consumer provide a printed version of a coupon to the point of sale? If the consumer does present a printed version of the coupon to the point of sale, the merchant enters the coupon information, as depicted at a step 506. The entering of the printed coupon information may include manually entering a unique identifier of the coupon into a point-of-sale equipment operated by the merchant (e.g., cash register). The entering of the information may also include scanning a barcode-like unique identifier to eliminate the time required to manually enter a unique identifier. When the consumer does not present a coupon, the method 500 proceeds on to a decision 508.

At the decision 508, a determination identifying if the consumer presents a digital copy of the coupon is made. For example, the consumer may have a copy of the coupon, or information elated to the coupon, stored or accessible by a mobile device. For example, the consumer may have the coupon communicated to a mobile device by way of a Short Message Service (i.e., text message). Additionally, in an exemplary embodiment the consumer has a copy of the coupon stored on a mobile device that may be displayed utilizing a display device of the mobile device. The display of the coupon may then be read by a barcode scanner or viewed by an employee of the merchant. Additionally, in an exemplary embodiment, the consumer may access a coupon storage account utilizing the mobile device. Upon accessing the coupon storage account, the consumer may present information related to the coupon at the point of sale. If a determination is made that, the consumer does present the digital copy of the coupon, the method 500 advances to a step 510. At the step 510, the merchant accesses the digital copy of the coupon. As previously discussed, the accessing of the digital copy of the coupon may include scanning a mobile device display, a merchant's employee reading the electronic copy, or the like. However, if the determination is that the consumer does not present an electronic copy, the method 500 proceeds to a step 512.

At the step 512, the merchant accesses a coupon storage account associated with the consumer. The merchant may access this account by way of a computing device coupled to a network. For example, the point-of-sale equipment utilized, such as a cash register, may have the ability to access the coupon storage account associated with the consumer by utilizing a connection with the Internet. Additionally, the merchant may utilize a computing device independent of the point-of-sale equipment to access the consumer's coupon storage account.

Access to the consumer's coupon storage account, in an exemplary embodiment, is allowed when a merchant provides a unique identifier of the consumer. For example, the merchant may be limited to accessing the consumer's coupon storage account unless the consumer provides a unique identifier. Examples of unique identifiers include the consumer's credit card information (e.g., account number, card information), the consumer's telephone number, a unique identifier of a mobile device (e.g., electronic serial number, mobile subscriber international ISDN number), a radio frequency identifier (RFID), an online identifier (e.g., email address, token, cookie, IP address, etc.) or the like. In this example, the merchant enters the unique identifier into an interface provided associated with the coupon storage account, where the unique identifier allows access to the coupon storage account. As a result, at a step 514, the merchant accesses the coupon from the coupon storage account.

At a step 516, the coupon is indicated as being utilized for a purchase from the merchant offline. For example, following the consummation of an offline transaction between the consumer and merchant for a good or service associated with the coupon, the coupon is indicated as having been utilized by the consumer for an offline purchase. As previously discussed, depending on the format in which the coupon was presented to the merchant, an indication as to the utilization of the coupon includes, but is not limited to, marking a physical copy of the coupon indicating the coupon has been utilized in a data base monitored by either the merchant and/or an advertisement-service provider. Further, the consumer's coupon storage account may also be altered to reflect an indication that the coupon has been utilized.

At a step 518, an advertisement-service provider reduces the debt owed to it by the merchant as a result of the utilization of the coupon. For example, the merchant may owe the advertisement-service provider an amount of money in return for the advertisement-service provider providing the coupon to an audience, such as the consumer. As an incentive, in this example, for the merchant to utilize the advertisement-service provider, the advertisement-service provider may reduce the merchant advertising expense by an amount as a result of the offline utilization of the coupon. Therefore, while the consumer receives an economic benefit from the utilization of the coupon (e.g., reduced sales price), the merchant is not responsible for the entire economic benefit conferred upon the consumer. Instead, the advertisement-service provider offsets a portion of the benefit by reducing the amount of money owed as a result of the merchant's use of the advertisement-service provider services.

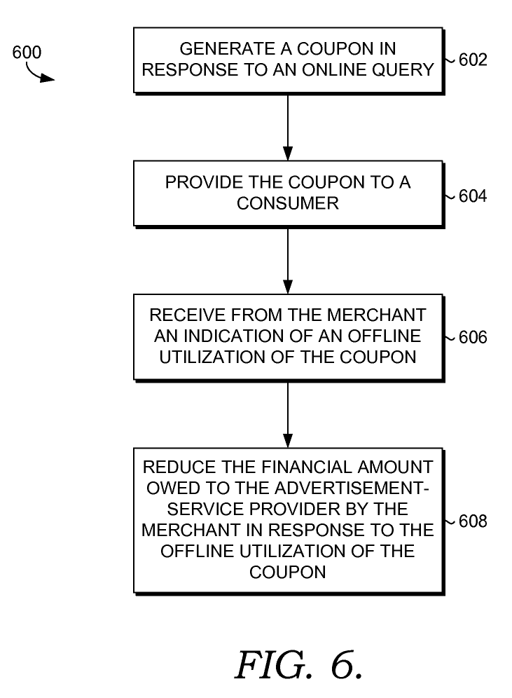

Turning to FIG. 6 that depicts a block diagram illustrating a method 600 for reducing merchant-related expenses owed to an advertisement-service provider in response to an offline consumer purchase in accordance with an embodiment of the present invention. At a step 602, in response to an online query a coupon is generated. For example, a search engine may access a coupon store that includes a plurality of coupons. The search engine may select a coupon, based on contextual relevance and/or associated keywords. Additionally, proximity information, such as user location information derived from a user account, Internet Protocol (IP) address, trilateration, or Global Positioning System (GPS) information may be utilized to generate a customized coupon. For example, the coupon may include the location of the closest merchant, direction to the merchant based on the proximity information, or other customized features, such as a known consumer preference.

At a step 604, the coupon is provided to the consumer. In an exemplary embodiment, the coupon is mailed through a postal service. In an additional embodiment, the coupon is emailed to the consumer. In yet an additional embodiment, the coupon is displayed on a display device coupled to a computing device from which the consumer entered the online query. Additionally, the coupon may also be presented by way of a wireless network to a mobile device.

At a step 606, an indication is received from a merchant. The indication indicates offline utilization of the coupon by the consumer. For example, the consumer may have purchased goods or services from a retail store, not an Internet site. The indication, in an exemplary embodiment, allows a correlation to be developed between the consumer's online research and presentation of the coupon to the consumer's offline purchase of goods or services. Therefore, in an exemplary embodiment, a unique identifier of the consumer is used by the merchant to access the consumer's coupon storage account, where upon the completion of the purchase, additional information is provided from the merchant to an advertisement-service provider in connection with the indication. The additional information may include a proof of purchase, such as a sales receipt or other accounting measures that provide reliable confirmation of the sale of the goods as a result of the utilization of the coupon. For this reason, it is advantageous for the merchant to access the consumer's coupon storage account to access the coupon, because, in this example, the merchant can provide the confirmation information along with the indication in return to the consumer's coupon storage account and/or the advertisement-service provider.

At a step 608, the financial amount owed to the advertisement-service provider by the merchant is reduced in response to the offline utilization of the coupon. Therefore, upon the receipt of an indication of utilization of the coupon, which may include additional confirmation information such as a proof of purchase, the advertisement-service provider credits the merchant's account.

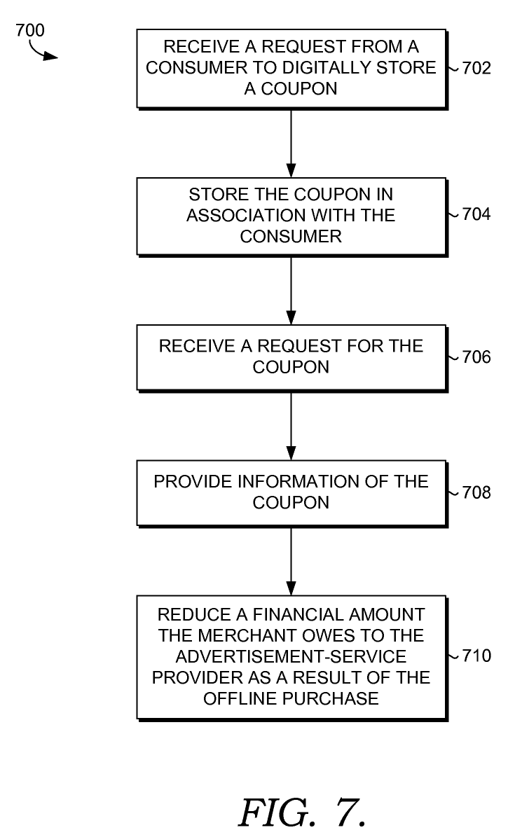

Turning to FIG. 7 that depicts a block diagram illustrating another method for reducing merchant-related expenses owed to an advertisement-service provider in response to an offline consumer purchase in accordance with an embodiment of the present invention. At a step 702, a request is received from a consumer to digitally store a coupon. In an exemplary embodiment, an advertisement-service provider receives the request to store a coupon. The coupon may be stored in a coupon storage account associated with the consumer. In an exemplary embodiment, the coupon is not stored, but instead information related to the coupon is stored. For example, a unique identifier of the coupon may be stored, where the unique identifier is useable for locating the coupon or deriving the same benefit as the originally presented coupon. The digital storage of the coupon occurs in an online environment.

At a step 704, the coupon is stored in association with the consumer. As previously discussed, the coupon may be stored in a coupon storage account associated with the consumer. In an additional embodiment, the coupon may be stored on a mobile device to which the coupon was originally received or to which the coupon is communicated, automatically or at the request of the consumer.

At a step 706, a request for the coupon is received. In an exemplary embodiment, the consumer requests the coupon for presentation to a merchant by way of a mobile device or other methods (e.g., print, unique identifier). In an additional embodiment, the request to receive the coupon originates from the merchant. The merchant may request the coupon from a computing device or a point-of-sale equipment.

At a step 708, the information of the coupon is provided. For example, information related to the coupon, such as the coupon's unique identifier that provides the benefits indicated by the coupon without superfluous data. The information may also include restriction on redemption, valid terms and conditions, etc. In an exemplary embodiment, providing information of the coupon includes the coupon as a whole. In an additional embodiment, the information includes data necessary to complete a transaction between the consumer and the merchant.

At a step 710, a financial amount the merchant owes to the advertisement-service provider is reduced as a result of the offline purchase. For example, the consumer purchases an item associated with the coupon, the merchant provides an economic benefit to the consumer as a result of the utilization of the coupon, and the advertisement-service provider reimburses the merchant for a portion of the economic benefit provided to the consumer. The reimbursement is in the form of a credit toward the total amount owed, or stated differently, the debt owed by the merchant is reduced. Additionally, the reduction of the debt may include reducing the Cost Per Click (CPC) or similar metrics the advertisement-service provider imposes on the merchant. Therefore, while an explicit deduction to an amount owed is not provided, a similar result occurs by reducing the CPC.

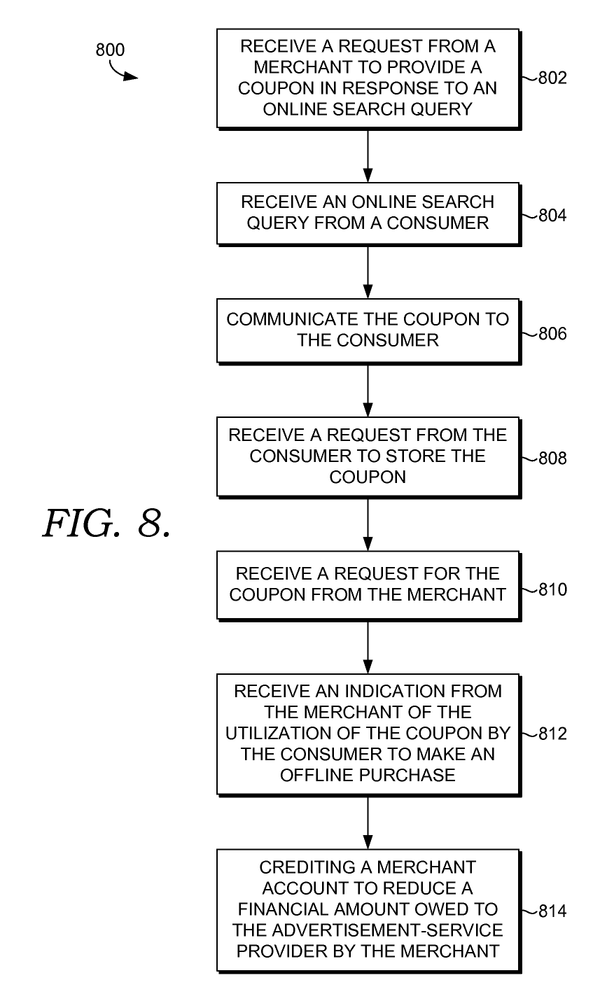

Turning to FIG. 8 that depicts a block diagram illustrating yet another method for reducing merchant-related expenses owed to an advertisement-service provider in response to an offline consumer purchase in accordance with an embodiment of the present invention. At a step 802, a request is received from a merchant to provide a coupon in response to an online search query. For example, the merchant may enter into a relationship with an advertisement-service provider, where the advertisement-service provider provides one or more advertisements to an audience in exchange for compensation from the merchant. Further, in an exemplary embodiment, the request to provide a coupon in response to an online search query is received by the advertisement-service provider.

At a step 804, an online search query is received from a consumer. For example, a consumer may employee an Internet search engine while researching a particular product or service. While using the search engine, the consumer enters a search query that is comprised of one or more keywords. The keywords may also be associated with the coupon. As a result, the coupon is identified and selected to be presented to the consumer. The presentation of the coupon includes communicating the coupon to the consumer, as illustrated at a step 806. Additionally, the coupon may be presented to the consumer in a variety of formats previously discussed (e.g., print, digital, SMS).

At a step 808, a request is received from the consumer to store the coupon. The consumer, in an exemplary embodiment, identifies the coupon is of interest and desired for later utilization. As a result, the consumer, in this example, selects the coupon for storage in a coupon storage account associated with the consumer, where the coupon storage account is managed by the advertisement-service provider.

At a step 810, a request is received from the merchant for the coupon. For example, once the consumer has stored the coupon, the consumer initiates the purchase of an item at an offline location of the merchant. In order for the consumer to derive the benefit of the coupon, the merchant is provided with the coupon. In an exemplary embodiment, the merchant is provided the coupon by the merchant requesting the coupon as stored in the consumer's coupon storage account maintained by the advertisement-service provider. In an exemplary embodiment, information related to the coupon is provided to the merchant to facilitate the completion of the consumer's purchase.

At a step 812, an indication is received from the merchant. The indication indicates the utilization of the coupon by the consumer to make an offline purchase. As a result of the indication, the advertisement, service-provider is aware that a purchase has been completed by the consumer utilizing the coupon. This information, in an exemplary embodiment, allows a relationship to be created between the consumer's online activity and the consumer's offline activity. As a result, the advertisement-service provider is able to identify an offline transaction has completed, at least in part, as a result of the online experience of the consumer.

At a step 814, a merchant's account is credited to reduce a financial amount owed to the advertisement-service provider by the merchant. Once the indication of utilization of the coupon in an offline environment has been received, and in some embodiments confirmed, the merchant's account is credited. Therefore, the merchant is reimbursed for a portion of the financial gain received by the consumer at the offline point of sale. Additionally, the advertisement-service provider is provided information as to the conversion of advertisements provided to the consumer through the advertisement-service provider.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A method for reducing merchant-related expenses owed to an advertisement-service provider in response to an offline consumer purchase, the method comprising:
generating a coupon in response to an online query submitted by a consumer, wherein the coupon is associated with a merchant;
providing the coupon to the consumer, wherein the coupon provides an economic benefit to the consumer when the coupon is utilized offline;
receiving, from the merchant, an indication of an offline utilization of the coupon by the consumer; and
reducing a financial amount owed to the advertisement-service provider by the merchant in response to the offline utilization of the coupon by the consumer.

2. The method of claim 1 further comprising receiving a request from the merchant to provide the coupon to one or more consumers, wherein the merchant incurs an expense as a result of presenting the coupon to the one or more consumers.

3. The method of claim 1, wherein the online query is submitted by the consumer utilizing an Internet search engine.

4. The method of claim 1, wherein the online query is a search for at least one of: a product, a service, or a merchant.

5. The method of claim 1, wherein the online query includes one or more keywords identified by the merchant to cause the generation of the coupon.

6. The method of claim 1, wherein providing the coupon is achieved by way of at least one of the following modes: as an electronic mail message, a Short Message Service (SMS), an Internet link, a printable format, or a physical delivery.

7. The method of claim 1, wherein the coupon is customized for the consumer.

8. The method of claim 1, further comprising:
receiving a request to store the coupon in association with the consumer;
receiving a request from the merchant for information pertaining to the coupon; and
communicating the information pertaining to the coupon.

9. The method of claim 1, wherein the economic benefit is at least one of:
a reduction in a price;
a rebate; or
a special incentive.

10. The method of claim 1, wherein the indication of offline utilization is automatically created as a result of the offline utilization of the coupon.

11. The method of claim 1, wherein the offline utilization is not a redemption of the coupon in an Internet environment.

12. The method of claim 1, wherein reducing of the financial amount owed to the advertising-service provider is limited to a percentage of the financial amount owed.

13. One or more computer-readable media having computer-executable instructions embodied thereon for performing a method for reducing merchant-related expenses owed to an advertisement-service provider in response to an offline consumer purchase, the method comprising:
receiving a request from a consumer to digitally store a coupon, the coupon entitles the consumer to an economic benefit when the coupon is utilized;
storing the coupon in association with the consumer;
receiving a request for the coupon;
providing information of the coupon, wherein the information includes a unique identifier of the coupon useable by a merchant to apply the economic benefit of the coupon to an offline purchase by the consumer; and
reducing a financial amount the merchant owes to the advertisement-service provider as a result of the offline purchase by the consumer.

14. The media of claim 13, wherein the request for the coupon is from the merchant.

15. The media of claim 13, wherein the request for the coupon is from the consumer.

16. The media of claim 17 further comprising communicating the information to the consumer by way of electronic mail or SMS.

17. The media of claim 13, wherein the request for the coupon includes a unique identifier of the consumer.

28. The media of claim 13, wherein the information is a unique identifier of the coupon, the unique identifier of the coupon is useable by the merchant to apply the economic benefit of the coupon to a purchase consummated by the consumer.

29. The media of claim 13, wherein the financial amount owed is a debt resulting from the advertisement-service provider providing an online advertisement for the merchant.

20. One or more computer-readable media having computer-executable instructions embodied thereon for performing a method for reducing merchant-related expenses owed to an advertisement-service provider in response to an offline consumer purchase, the method comprising:
receiving a request from a merchant to provide a coupon in response to an online search query for an identified keyword;
receiving an online search query from a consumer, wherein the online search query is comprised of the identified keyword;
communicating the coupon to the consumer;
receiving a request from the consumer to store the coupon, wherein the coupon is stored in association with an identifier of the consumer;
receiving a request for the coupon from the merchant, wherein the request includes the identifier of the consumer;
receiving an indication from the merchant of the utilization of the coupon by the consumer to make an offline purchase from the merchant;
crediting a merchant account, wherein the credit reduces a financial amount owed to the advertisement-service provider by the merchant.
